(19) United States
(12) Patent Application Publication
(10) Pub. No.: US 2011/0139297 A1
(43) Pub. Date: Jun. 16, 2011

(54) Column Vapor recovery

(76) Inventor: William T. Cutts, Houston, TX (US)

(21) Appl. No.: 12/931,959

(22) Filed: Feb. 15, 2011

Related U.S. Application Data
(63) Continuation-in-part of application No. 12/080,731, filed on Apr. 4, 2008.

(51) Int. Cl. B65B 3/04; B65D 90/30; F15D 1/00

(52) U.S. Cl. 141/5; 220/565; 137/1

(57) ABSTRACT

A steel storage tank with a novel structure for recovering vapors through perforations in the center column is described. Vapors trapped between the floor and the minimum elevation of a floating roof fluid storage tank are recoverable through perforations in the supporting center column. The vapors are removed through adjustable elevation vents in the center column where they are routed to a vapor recovery system.

This application is a continuation-in-part of application Ser. No. 12/080,731, filed on Apr. 4, 2008.

### BACKGROUND OF THE INVENTION

1. Field of the Invention

The present invention pertains to fluid storage tanks. More particularly, the present invention pertains to fluid storage tanks of the type having a floating roof Still more particularly, the present invention relates to a method and apparatus for recovering vapor in steel storage tanks utilizing a center column.

2. Description of the Related Art

Many types of fluids are stored in tanks having a bottom, vertical sidewalls and a roof. Many tank roofs are fixed. However, other tanks are provided with floating roofs that cover the stored fluid and ride up and down on the fluid surface therein in response to changes in the volume of fluids within the tank. Accordingly, vapor space within the tank is kept at a minimum. This reduces the loss of fluids from evaporation and reduces the hazards associated with vapors, in particular hydrocarbon vapors.

The floating roof of a floating tank is typically constructed of metal sheets or aluminum welded or bolted together to form a circular deck with a rim around its edge to prevent fluids stored in the tank from escaping from beneath the floating roof Most, if not all, floating roof tanks are provided with some type of roof support that allows the floating roof to be supported at some elevation above the bottom of the tank when there is little or no fluids therein. There is normally a minimum elevation in which the roof should be supported to prevent it from being position below the tank inlets or outlets. If the roof is positioned below the inlets or outlets then when additional fluid enters the tank it would result in the roof sinking. At other times, it is desirable to support the roof at even higher elevations to provide enough room below the floating roof for workers performing cleaning, painting, or other service operations. This allows both personnel and equipment easy access under the roof for performing these operations. In addition, the work may be cared out in a safe manner.

While floating roof tanks minimize vapor loss, conventional floating roof tanks provide no means to safely recover the vapors trapped below the floating roof when the tank is empty. Therefore, there exists a need for an improved floating roof tank that provides a means for safely recovering residual vapors left once the floating roof has landed.

### BRIEF DESCRIPTION OF THE DRAWINGS

This invention is described in a preferred embodiment in the following description with reference to the drawings, in which like numbers represent the same or similar elements, as follows:

FIG. 1 is an elevation view, particularly broken away and in section, of an improved fluid storage tank of the floating roof type, according to a preferred embodiment of the present invention.

FIG. 2 depicts a structural diagram of the support for the external roof and the center column of the present invention.

FIG. 3 is a structural diagram of the cap plate of the center column containing a conduit for recovering vapor according to a preferred embodiment of the present invention.

FIG. 4 illustrates a structural diagram of the lower portion of the center column of the storage tank containing adjustable ports and an adjustment plate.

FIG. 5 is a flow chart describing the method of the present invention for recovering vapor in storage tanks with floating roofs.

### DETAILED DESCRIPTION OF PREFERRED EMBODIMENTS

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

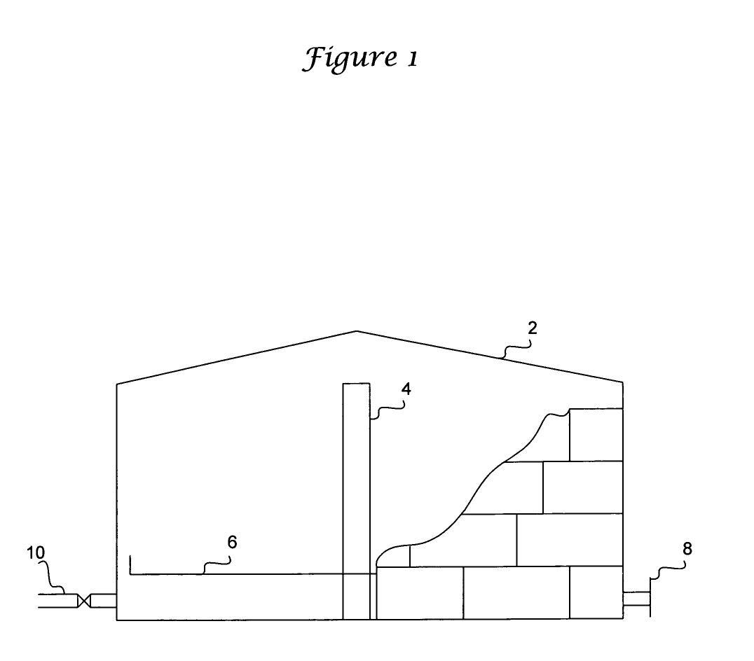

With reference to FIG. 1 there is depicted a fluid tank with a floating roof and external roof supported by a center column. While depicted as having an external roof, an external roof is not necessary to implement or practice the present invention. Fluid storage

Tank 2 has a flat bottom and cylindrical walls. The cylindrical walls may be formed by welding sections of metal plate in the form of a cylinder.

Tank 2 comprises inlets/outlets collectively depicted as element 10. Additionally, manhole 8 provides a means for service personnel to enter and perform maintenance on Tank 2.

Disposed in Tank 2 for movement therein is Floating Roof 6 that includes a circular deck and upwardly projecting rim. When fluids are stored in Tank 2, beneath Floating Roof 6, Floating Roof 6 floats upwardly and downwardly on the surface of the fluid stored therein. The rim of the floating roof prevents the fluid from escaping to the upper side of the roof.

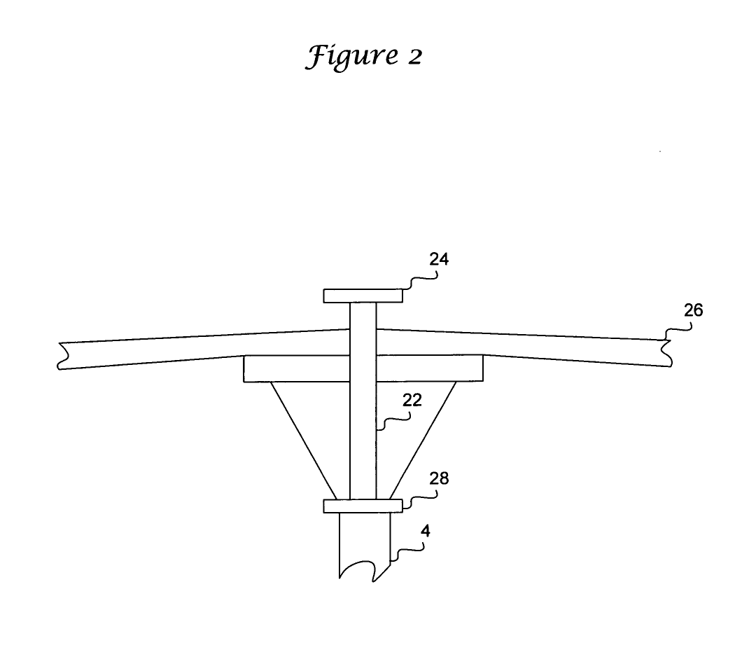

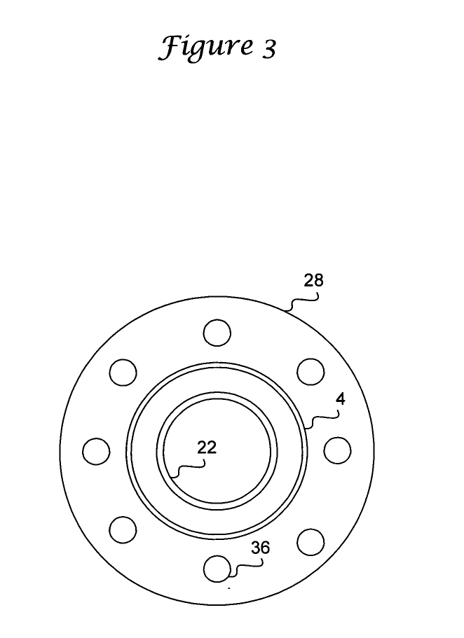

Center Column 4 is structural support attached to the bottom of Tank 2. The upper end of Center Column 4 may be attached to the fixed roof of Tank 2 or attached to the sidewalls in a suitable fashion. The means of securing Center Column 4 does not impact the present invention and are given by way of illustration only. The top and bottom portions of Center Column 4 are examined in more detail with respect to FIG. 2 and FIG. 3.

While not depicted in FIG. 1, a person of ordinary skill in the art will readily acknowledge that Floating Roof 6 and Tank 2 contain a means for preventing Floating Roof 6 from reaching the minimum elevation in Tank 2. If Floating Roof 6 rests on the bottom of Tank 2 and fluid is pumped into Tank 2, Floating Roof 6 may become submerged. The use of legs on the bottom of Floating Roof 6, or other means, or the floor of Tank 2 may be utilized to prevent Floating Roof 6 from becoming submerged.

With reference now to FIG. 2, a structural diagram of the top of Center Column 4 and surrounding apparatus of the preferred embodiment is shown. Center Column 4 is attached to Tank Roof 26 through Column Cap Plate 28, depicted in further detail in FIG. 3. In alternative embodiments, Center Column 4 is attached to the cylindrical walls of Tank 2.

Vapor Recovery Pipe 22 is fitted inside of Center Column 4 and provides a means for recovering vapor below Floating Roof 6 that articulates upwardly and downwardly on Center Column 4. While depicted as a single pipe, the means of transporting vapor through the column may comprise a plurality of tubes or a transformation of the center column into a suitable transport means via an inner coating or lining. Vapor Recovery Pipe 22 may be either flexible or nonflexible material without departing from the spirit or scope of the present invention

On the upper most termination of Vapor Recovery Pipe 22 is Cap Plate 24. In a preferred embodiment, Cap Plate 24 is connected to a vapor handling system (not depicted). In one such preferred embodiment, the vapor handling system is a flare system that burns the recovered vapors. In another preferred embodiment, the vapor handling system is a vapor condenser.

Separate from and in addition to a flare system, vapors in an alternate embodiment are re-circulated to the storage tank and condensed to become liquid again. In yet another embodiment, the vapors are moved to a source that requires vapor for balancing of pressures. In still another embodiment, the vapors are used in a process of consumption

With reference now to FIG. 3, a structural diagram of Column Cap Plate 28 is illustrated. Column Cap Plate 28 secures the upper end of Center Column 4 to the fixed roof of Tank 2. In a preferred embodiment supporting members are attached to a plurality of bolt locations 36 on Column Cap Plate 28 and to a structural support area on the roof of Tank 2 as depicted in FIG. 2.

Column Cap Plate 28 comprises an open area in the center large enough to permit Vapor Recovery Pipe 22 to extend from above Center Column 4 through Column Cap Plate 28 downward to a desired elevation.

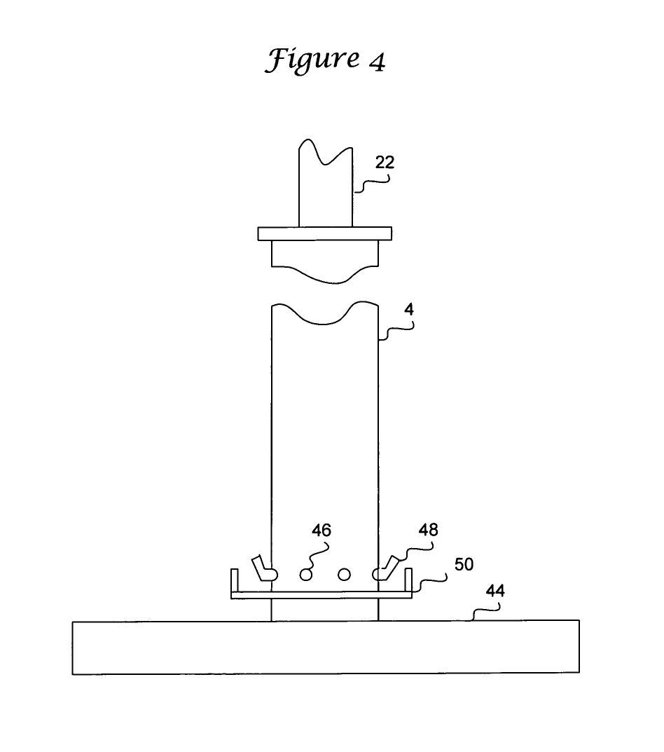

With reference now to FIG. 4, a structural diagram of the lower end of Center Column 4 is shown. Center Column 4 rests on Tank Bottom 44 and extends upward to Column Cap Plate illustrated in FIG. 3. Vapor Recovery Pipe 22 extends toward the bottom of Center Column 4 where one or more ports depicted as element 46 are located. It is not essential to the practice of the present invention that Vapor Recovery Pipe 22 extend entirely to Tank Bottom 44, however, in a preferred embodiment, Vapor Recovery Pipe 22 rests on

Tank Bottom 44. The one or more Ports 46 in Center Column 4 are connected to Vapor Recovery Pipe 22 through a short pipe if required.

After construction of Tank 2, it is possible that the elevation of Center Column 4 will change due to the weight and ground conditions. Therefore, in a preferred embodiment of the present invention, Ports 46 have Elevation Adjustment Pipes 48 attached. If Center Column 4 sinks into the ground, Elevation Adjustment Pipes 48 are utilized to change the elevation of vapor recovery. In a preferred embodiment, Elevation Adjustment Pipes 48 extend upward from Ports 46 to the desired vapor recovery elevation.

Center Column 4 includes Adjustment Plate 50 for adjusting the elevation of Elevation Adjustment Pipes 48. In a preferred embodiment, the Adjustment Plate 50 is located below Ports 46 with and has an skirt that faces upward. In other embodiments, Adjustment Plate 50 can have a skirt facing downward and/or be located above Ports 46.

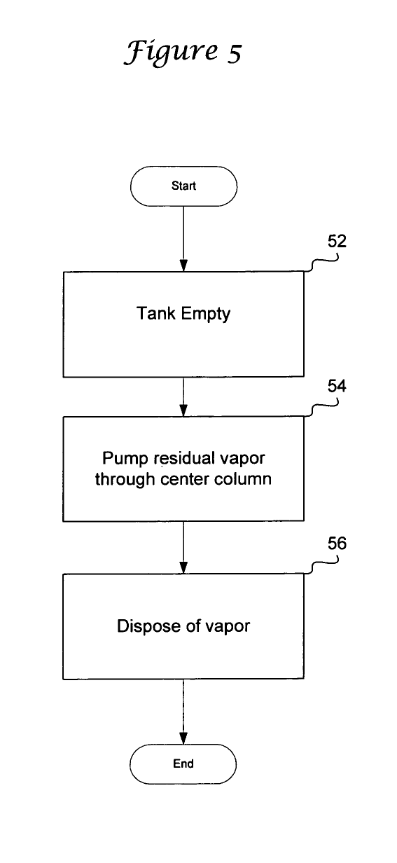

With reference now to FIG. 5, a flow chart for the method of the present invention for recovering vapor in fluid storage tanks with a center column is depicted.

The method of the present invention begins at Step 52 when liquid contained in a center column tank is empty. Typically, the liquid is removed for consumption in a process or for transportation to another location. The tank is empty prior to filling while the roof is landed or after the liquid has been removed from the tank.

Following the removal of the liquid from the tank, a rich vapor between the floor of the tank and the lowest elevation of the floating roof is trapped. The common practice is to vent the vapor to the atmosphere, which is an environmental concern for many of the chemicals stored in these types of tanks. There are also safety concerns for venting the vapors and the possibility of contaminating the stored product.

The present invention differs from the current art as the process moves to Step 54. In Step 54, the vapors trapped beneath the floating roof are pumped through the center column from the tank through an apparatus similar to or the same as the ones described in FIGS. 1-4. In a preferred embodiment, the vapor is first pumped through ports in the center column of the tank, then upward through the center column where it reaches the termination of the vapor recovery pipe in the center column. When the vapor reaches this point additional pipes are used to transport the vapor to disposal and it is no longer considered to be inside of the fluid storage tank.

As the process moves to Step 56, the vapor that has reached the end of the vapor recovery pipe is transmitted to a vapor disposal system. In a preferred embodiment, the vapor disposal system comprises a flare that burns the vapors. In yet another preferred embodiment, the vapor is condensed to a liquid. The condensed liquid is then combined with the liquid pumped from the tank in yet another embodiment.

Following the disposal of the residual vapor the method of the present invention is concluded.

While the invention has been particularly shown and described with reference to preferred embodiments, it will be understood by those skilled in the art that various changes in form and detail may be made therein without departing from the spirit and scope of the invention. Any variations, modifications, additions, and improvements to the embodiments described are possible and may fall within the scope of the invention as detailed within the following claims.

What is claimed is:

1. A steel storage tank comprising:
a pipe type center column structural support with a means for recovering a vapor from the storage tank, wherein the pipe type center column structural support comprises an elevation adjustment plate.

2. The steel storage tank of claim 1, wherein the pipe type center column contains one or more ports and supports a fixed roofing structure of the steel storage tank.

3. The steel storage tank of claim 2, wherein the one or more ports are located near the bottom of the pipe type center column.

4. The steel storage tank of claim 2, wherein a pipe attached to the one or more ports located near the bottom of the pipe type center column is one or more elevation adjustment pipes for adjusting an elevation in the tank for recovering vapor.

5. The steel storage tank of claim 1, wherein said center column is attached to a means for disposing of the vapor.

6. The steel storage tank of claim 5, wherein said means for disposing of the vapor comprises a flare system.

7. The steel storage tank of claim 1, wherein said means for recovering the vapor is a pipe fitted inside of the center column.

8. The steel storage tank of claim 5, wherein said means for disposing of the vapor comprises a vapor condensation system.

9. The steel storage tank of claim 5, wherein said means for disposing of the vapor comprises a system that consumes the vapors.

10. A method of recovering vapors from a steel tank containing a liquid, said method comprising:
Removing the liquid from the tank;
Removing vapors from the tank through a pipe type center column structural support wherein the pipe type center column structural support comprises an elevation adjustment plate.

11. The method of claim 10, wherein the center column comprises:
A means for recovering vapors; and
the center column supports a fixed roofing structure of the steel storage tank

12. The method of claim 11, wherein said means for recovering vapor comprises one or more ports in the center column.

13. The method of claim 11, wherein said means for recovering vapor comprises a pipe fitted inside of the center column.

14. The method of claim 10, said method further comprising the step of disposing of the vapors removed from the storage tank.

15. The method of claim 14, wherein the step of disposing of the vapors comprises sending the vapors to a flare system.

16. The method of claim 14, wherein the step of disposing of the vapors comprises sending the vapors to a vapor condensation system.
